(19) United States
(12) Patent Application Publication
(10) Pub. No.: US 2004/0224104 A1
(43) Pub. Date: Nov. 11, 2004

(54) Ink jet recording medium

(75) Inventors: Ieke de Vries, Kaatsheuvel (NL); Iskandar Gandasasmita, Tilburg (NL); Fuyuhiko Mori, Fujinomiya (JP)

Correspondence Address: BANNER & WITCOFF, LTD., 28 STATE STREET, 28th FLOOR, BOSTON, MA, 02109-9601, US

(73) Assignee: Fuji Photo Film B.V., Tilburg (NL)

(21) Appl. No.: 10/778,949

(22) Filed: Feb. 13, 2004

Related U.S. Application Data
(63) Continuation of application No. PCT/NL02/00430, filed on Jul. 2, 2002.

(30) Foreign Application Priority Data
Aug. 15, 2001 (EP) 01203111.8

(51) Int. Cl. B41M 5/00

(52) U.S. Cl. 428/32.18

(57) ABSTRACT

The invention is directed to an ink jet recording medium comprising at least: a support, and a microporous film adhered to said support, wherein said microporous film is characterised by: an oriented thermoplastic film comprising at least a filler, said film having interconnecting channels between the pores, with a void volume between 30 to 80 volume percent of the total microporous film, and having a volume of pores with a pore diameter between 50 nm and 1000 nm of less than 60 volume % of the total void volume of said microporous film, as determined by the mercury intrusion porosimetry method.

### FIELD OF INVENTION

The present invention relates generally to an ink jet recording medium, preferably of photographic quality, that has excellent ink absorption speed, good wettabiity characteristics and a good image printing quality.

### BACKGROUND OF THE INVENTION

There are in general two approaches for producing ink jet recording media with photographic quality. Both approaches have unresolved deficiencies and problems.

The conventional approach, the so called “non-microporous film type” ink jet media, is proposed in several patent publications such as DE-A 4322178, EP-A 0806299, JP 2276670, and JP 5024336.

For this type of ink jet recording medium, at least one ink receptive layer is coated on a support such as a paper or a transparent film. The ink receptive layer typically contains various proportions of water soluble binders and fillers. The proportions of these components affect the properties of the coatings e.g. ink absorption properties and the gloss quality appearance of the ink jet media.

One of the important properties of an ink jet receptive coating formulation is the liquid absorptivity. The majority, if not all, of the ink solvent has to be absorbed by the coating layer itself. Only when paper or cloth or cellulose is used as a support, some part of the solvent may be absorbed by the support. It is thus obvious that both the binder and the filler should have a significant ability to absorb the ink solvent.

Another important property for an ink jet recording medium having photographic quality, is the glossiness of the surface. It has been a research theme for more than 10 years to find a good balance between a high ink solvent absorptivity and at the same time a high gloss value for an ink jet media.

In WO-A-00/02734 it has been described that the gloss and the permeability properties of the ink receptive coating depend very much on the concentration of the filler volume. Relatively glossy coatings can be achieved when the filler volume is small. This can be realised by choosing relatively small filler particles compared to the coating thickness. However, unless the binder is very hygroscopic, such a coating will be relatively impermeable to ink-solvent. This will result in a long drying time for the ink-solvent. And in some cases, it will lead to an unacceptable smudge problem.

In order to increase the ink-solvent absorbtivity, it is suggested among others in EP-A 0634287, JP 08/282,088, JP 08/290,654, and JP 2000-108501, to coat multiple layers on the support. The first coating layer formed directly on the surface of the support is designed to have a high solvent absorbtivity. The ink receptive layer that is coated as a second layer on top of the first layer, is responsible for a good gloss and colour density. In this design, there are more variables that can be utilised for adjusting the balance between the gloss and ink-solvent absorptivity properties, e.g. the ratio of binder and inorganic particles in the ink-receptive layer which is generally lower than that in the layer below, the usage of other inorganic particles in the upper most layer than those in the layer below, such as alumina hydrate for the upper most layer and silica gel for the under layer, and the usage of different inorganic particles size between the ink-receptive layer and the layer below.

Although a significant improvement is seen in the absorbtivity and the gloss appearance, this concept has a major disadvantage in the manufacturing process thereof. The process for manufacturing a multiple coating of filler and binder mixtures on a support is relatively slow. It is believed that the combination of an increase in the coating load and the process to coat the multiple layers containing a large amount of binder and filler particles, have significantly caused the slow manufacturing process.

Recently, a lot of investigations has been directed to the field of ink jet recording media, wherein a hygroscopic microporous membrane is involved. This so called “microporous film type” is superior to the non-microporous type especially due to its high absorption speed for the ink-solvent. By this method the drying time for the ink solvent decreases significantly. U.S. Pat. No. 4,861,644, U.S. Pat. No. 5,605,750, WO-A-99/07558 and EP-A 0995611 provide some examples of the methods.

In this microporous type, the microporous film has the primary function to absorb the ink solvent. The typical microporous film suitable for this purpose is described among others in U.S. Pat. No. 4,833,172, U.S. Pat. No. 4,861,644 and U.S. Pat. No. 5,326,391 and commercially available under the name TESLIN®. The major part of the microporous film comprises expensive precipitated silica particles, which is suitable for absorbing the ink solvent. This type of microporous film, which is biaxially oriented, has a typical average pore diameter of larger than 4 μm. Accordingly, the glossiness of said microporous film is very low. Also other hydrophilic microporous films, which are commonly used for filtration purposes are also suitable to be used for the ink solvent absorbing layer.

In U.S. Pat. No. 5,605,750 and WO 99/41086, it is suggested further to apply an ink receiving layer on top of the microporous film in order to increase the colour density, glossiness, etc.

Another disadvantages of the above mentioned microporous film is its thickness, which is commercially available in a minimum thickness of 150 μm. This thickness is too thick to be readily laminated onto a base paper support commonly used in the photographic industry. Hence, it would be necessary to adjust the thickness of the regular photographic base paper support or adjust the process conditions as such that we still be able to produce the photographic ink jet media according to the determined quality standard. Either way, the above mentioned adjustments to existing lamination processes is undesired and economically not favourable.

There are a lot of other microporous films with a comparable void volume which are significantly thinner (thickness less than 150 μm) and cheaper than the said hydrophilic microporous film. Some examples thereof have been described in WO-A 9619346, BE-A 1012087, EP-A 0283200 and U.S. Pat. No. 4,350,655. These microporous films are usually applied in the products that have a limited use and for disposable goods. Examples of such products include medically related products such as surgical drapes and gowns, disposable personal care absorbent products such as diapers and sanitary napkins, protective clothing, sport wears and the like.

The microporous films produced according to the above-mentioned BE-A-1 012 087 as well as films produced by the other above-mentioned methods, are typically permeable for gas, but are water repellent, because of their intended use (surgical drapes and gowns, disposable personal care absorbent products, etc.). These kinds of film are thus not readily suitable to be used in the ink jet material since it has an unacceptable low absorbing speed for ink jet solvent. It is believed that the water repellent property of these films is caused by the polyolefin resin content of the films which is hydrophobic and the manufacturing method which involving treatment of the filler particles with fatty acids salts, silicone oils or with silanes. The filler particles, which are usually calcium carbonate that is white and low in price, need to be treated in order to make the filler hydrophobic and to obtain a polymer loading amount which is preferably higher than 65 wt %.

There remains a need for having a film that is suitable to be used as an ink solvent absorbing layer for the ink jet media, which properties are a combination of both type of said microporous films, i.e. a film that is thin enough, has enough void volume, has high ability to absorb the ink solvent and is cheap. It is towards fulfilling this need that the present invention is directed.

### SUMMARY OF THE INVENTION

The object of the present invention is thus to provide an ink jet recording medium comprising a microporous film, said recording medium having advantageous properties in relation to ink absorption speed, wettability characteristics and an image printing quality, more in particular being suited to produce images of photographic quality.

In accordance with the present invention, there is provided an ink jet recording medium comprising at least: a support, and a microporous film adhered to said support, wherein said microporous film is characterised by:

an oriented thermoplastic film comprising at least a filler,

said film having interconnecting channels between the pores, with a void volume between 30 to 80 volume percent of the total microporous film, and

having a volume of pores with a pore diameter between 50 nm and 1000 nm of less than 60 volume % of the total void volume of said microporous film, as determined by the mercury intrusion porosimetry method.

Another aspect of this invention is to provide ink jet media comprising a support and a microporous film wherein the average pore diameter is between 50 nm and 1000 nm, as determined by mercury intrusion porosimetry, which is obtainable by the above-mentioned method of BE-A-1 012 087. Accordingly, another aspect of the present invention is the use of a specific microporous film in ink jet media, which microporous film is obtainable by a method comprising the successive steps of:

preparing a mixture consisting of a polyolefin matrix, containing at least one polymer and at least one mineral and/or organic filler; extruding at least one ply by hot-casting the mixture;

pre-stretching the ply with a drag roll;

cooling and solidifying the pre-stretched ply using the drag roll;

drawing the solidified ply at sufficient temperature to form the micro-porous film, whereby:

the cooling of the pre-stretched melting ply by the drag roll is partial and limited in a controlled manner at a temperature within the range required for its drawing; and

the drawing of the ply, brought to the required temperature for drawing through partial cooling is carried out by traction at the time of its tangential separation from the drag roll, the said roll acting as take-up roller for drawing.

Still another aspect of this invention is to improve the absorption speed of the microporous film for the ink-jet ink solvent by mixing the thermoplastic resin with fillers and anti-fogging agent prior to casting extrusions said resin mixture.

It is also our aim to further increase the absorption speed of the ink jet media by treating said microporous film after adhering said film onto the support with an aqueous solution comprising a surfactant.

### DETAILED DESCRIPTION

The present invention is directed to an ink jet recording medium wherein a thin microporous film is involved. The original properties of said microporous film is characterised by its high porosity, its hydrophobic character towards aqueous liquid and its high permeability for gasses and water vapour.

The porous films of this invention are typically produced by the processes involving the steps of: mixing thermoplastic polymers with at least one filler, extruding the mixture at an elevated temperature to form a web, pre-stretching and cooling the web by using a drag roll in order to solidify the web, and stretching the web at an adequate temperature to form a microporous film. A method comprising these steps is described in the above-mentioned BE-A-1 012 087. The material obtained by the method described in the BE-A-1 012 087 is very suitable to obtain the microporous films for use in the present invention. This method comprises the following successive steps:

preparing a mixture consisting of a polyolefin matrix, containing at least one polymer and at least one mineral and/or organic filler; extruding at least one ply by hot-casting the mixture;

pre-stretching the ply with a drag roll;

cooling and solidifying the pre-stretched ply using the drag roll;

drawing the solidified ply at sufficient temperature to form the micro-porous film, whereby:

the cooling of the pre-stretched melting ply by the drag roll is partial and limited in a controlled manner at a temperature within the range required for its drawing; and

the drawing of the ply, brought to the required temperature for drawing through partial cooling is carried out by traction at the time of its tangential separation from the drag roll, the said roll acting as take-up roller for drawing.

Preferably in the film obtained by this method the volume of pores of diameter larger than 1000 nm is also at least 40 percent by volume of the total void volume of said microporous film. This method is particularly suitable because films with a desired thickness may be produced. The typical thickness of the microporous film produced according to the method mentioned in this invention is less than 150 μm. The preferable thickness is between 15 and 60 μm, more preferably from 15 to 55 μm. Microporous film of less than 15 μm is believed to have a weak physical properties, especially its tear strength properties. On the other hand, said film having a thickness of higher than 150 μm is also not favourable since it is too thick to be readily adhered on our standard support. It was found that films having a desired low thickness combined with the desired pore size distribution cannot be obtained by conventional processes, such as the processes described in WO-A-99/41086 and U.S. Pat. No. 5,605,750

Stretching of the web may be performed in the conventional way by using various well-known stretching equipment. The web is at least stretched in the longitudinal stretching direction above its elastic limit. The stretch ratio is usually chosen in the range of 1.5 to 10. Preferably the stretch ratio is in the range of 2 to 6. As used herein, the stretched ratio is determined by the formula:

S=L₂/L₁

where S is the stretch ratio, L₁ is the distance between two reference points located on the intermediate product and on a line parallel to the stretching direction, and L₂ is the distance between the same two reference points located on the stretched microporous film.

The temperature at which stretching is accomplished may vary widely. In most cases, the film surface temperatures during stretching are in the range of from 20° C. to 220° C. The preferable temperatures are in the range of 40° C. to 165° C. and ideally between 5500 and 130° C.

The microporous film may optionally be stretched in the transversal direction after accomplishing the longitudinal stretching. The transversal stretch ratio lies generally between 1.1 and 10. The preferable transversal stretching ratio is between 1.1 and 4. Generally the degree of the stretching is as such that the required pore volume and the claimed pore size distribution are obtained.

According to the present invention, the pores should constitute from 30 to 80 percent by volume of the microporous film. As used herein, the porosity of the microporous film, is determined according to the equation:

Porosity=100*[1−(ρ_{E}/ρ_{A})]

where ρ_{E} is the envelope (or apparent) density of the microporous film and ρ_{A} is the absolute sample density. Both the envelope density and the absolute density of the microporous film have the units of gram per ml and are determined by the mercury porosimetry using Autopore IV 9500 apparatus (Micromeritics Corp.) in accordance with the accompanying operating manual and software programs.

When the porosity of the microporous film is lower than 30 percent, the capacity of the film to absorb the ink jet solvent becomes too low. Accordingly the drying speed of the ink jet medium becomes unacceptable low. On the other hand, porosity of higher than 80 percent is hardly being produced by the above mentioned production method and usually a microporous film with such a high porosity has a low tensile strength properties.

According to this invention, the total void volume of the microporous film is at least 0.3 ml per gram, since void volume of less than 0.3 ml/gram is too low for having an acceptable absorption speed for ink jet solvent.

Surprisingly, it has been found that the average pore diameter, which is determined by said mercury porosimetry, of the microporous film has a significant effect on the absorption speed of an ink jet solvent.

It has been discovered by this invention that the suitable range for the average pore diameter of the microporous film is between 50 nm and 1000 nm. The absorption speed of an ink jet solvent is very low at average pore diameter smaller than 50 nm. The larger the average pore diameter is, the quicker the absorption speed will be. However, a large average pore diameter affects the glossiness of the microporous film negatively. There is thus a balance between a glossy surface and a high absorption speed for the ink jet solvent. The glossiness of the surface of said microporous film at an average pore diameter bigger than 1000 nm, is regarded as not acceptable.

It is surprisingly found that the pore size distribution of said microporous film plays an important role.

According to this invention, an acceptable absorption speed is especially obtained when the pore volume of said microporous film having pore diameters between 50 nm and 1000 nm is less than 60 percent of the total void volume, and the volume of pores having pore diameters bigger than 1000 nm is at least 40 percent.

It is believed that the capillary force, which has a significant impact on the absorption mechanism, is mainly determined by the presence of the small pore diameters. At the same time we also need to have a sufficient void volume in the microporous film, which can be effectively created by the bigger pore diameters. Without being bound with it, it is believed that pore diameters between 50 nm and 1000 nm have significant contribution to the capillary forces of the microporous film, whereas the pore diameters larger than 1000 nm, is essential for creating sufficient void volume. A good balance between absorption speed and absorption capacity seems to lie in the said pore size distribution. The distribution of the pore diameter versus its void volume of said microporous film may have a single peak or multi peaks.

The amount of filler added to the thermoplastic polyolefin and the suitable filler size depend on the desired properties of the microporous film including tear strength, water vapour transmission rate, stretchability and void volume. It is believed that the void volume created in the microporous film can not be reached sufficiently for the invention mentioned herein with an amount of filler less than about 30 percent by weight. The more we are able to increase the filler amount, the more suitable the film will be due to the increase of the void volume and porosity. The maximum filler loading for producing the microporous film is 85 percent by weight. The preferable range for the filler load according to this invention is between 35 and 80 weight percent. Loading degree of higher than 85 percent will make the film becomes rigid and it will lead to some stretching difficulties. It may be necessary to coat the inorganic filler with fatty acids such as fatty acid ester, silicone oil or silanes, in order to reach the desired loading degree.

The average particle size of the filler is generally less than 40 μM and is preferably in the range of 0.5 and 10 μm. The desired pore distribution of the microporous film may be obtained by using fillers which have a single average particle size or a mixture of at least two different average particle sizes. According to this invention, a better balance between the pore size distribution, the porosity and the glossiness of the microporous film can be achieved by utilising at least two fillers, wherein the ratio of the biggest average particle size over the smallest average particle size is at least 1.5. Especially for a thicker microporous film, where we need to use a larger particle size in order to have sufficient porosity and volume of interconnecting pores while maintaining the high gloss value, it will be very beneficial to use two or more fillers having different average particle sizes.

The thermoplastic polymers suitable for manufacturing the microporous film are available in a huge number and kinds. In general, any substantially water-insoluble thermoplastic polymers, that can be extruded, calandered, pressed or rolled into film, sheet, strip or web may be used.

The polymer may be a single polymer or a mixture of polymers. The polymers may be homopolymers, copolymers, random polymers, block copolymers, atactic polymers, isotactic polymers, syndiotactic polymers, linear polymers, or branched polymers. When mixtures of polymers are used, the mixtures may be homogeneous, or it may comprise two or more polymeric phases. Examples of classes of suitable thermoplastic polymers include the polyolefins, poly(halo-substituted polyolefins), polyesters, polyamides, polyurethans, polyureas, polystyrene, poly(vinyl-halides), poly (vinylidene halides), polystyrenes, poly(vinyl esters), polycarbonates, polyethers, polysulfides, polyimides, polysilanes, polysiloxanes, polyeaprolactames, polyacrylates, and polymethacrylates. Examples of suitable thermoplastic polymers include high density polyethylene, low density polyethylene, ultra high molecular weight polyethylene, polypropylene (atactic, isotactic or syndiotic), poly(vinyl chloride), polytetrafluroethylene, copolymers of ethylene and alpha-olefines, copolymers of ethylene and acrylic acids, copolymers of ethylene and methacrylic acids, copolymers of ethylene and vinyl acetate, copolymers of propylene and alpha-olefines, poly(vinylidene chloride), copolymers of vinylidene chloride and vinyl acetate, copolymers of vinylidene chloride and vinyl chloride, copolymers of ethylene and propylene, copolymers of ethylene and butene, poly(vinyl acetate), polystyrene, poly(omega-aminoundecanoic acid), poly(-methyl methacrylate), poly(hexamethylene adipamide), poly(epsilon-caprolactam).

The preferred thermoplastics are polyolefin comprising polyethylene, polypropylene, co-polymers of ethylene and alpha-olefines, co-polymers vinyl ethylene-acetate, methyl ethylene-acrylate, ethyl ethylene-acrylate, acrylic ethylene-acid and the ionomers, and the mixture thereof.

The fillers can be selected either from the groups of organic fillers and inorganic fillers. The examples of organic fillers include wood particles, pulp particles, cellulose type particles, polymer particles such as Teflon™ particles and Kevlar™ particles, nylon particles dispersed in polypropylene, polybutylene terephthalate particles in polypropylene, and polypropylene dispersed in polyethylene terephthalate. The important characteristics of these organic fillers are it size and the shape of the particles. Spheres are preferred and they can be hollow or solid.

Examples of the inorganic fillers are included the groups consisting of calcium carbonate, clay, silica, titanium dioxide, talc, clay, kaoline, magnesium sulphate, barium sulphate, calcium sulphate, aluminum hydroxide, magnesium hydroxide, calcium hydroxide, magnesium oxide, zinc oxide, zeolite. The preferred filler is calcium carbonate, silica, barium sulphate, titanium dioxide or mixture thereof.

It has been found during our experiments that the surface tension and the amount of ink solution injected during printing are not the same for all brands of the ink jet ink. Depending on the type and the brand name of the ink jet ink, it is possible to further improve the absorption speed of the microporous film. The addition of an anti fogging agent into the mixture of the thermoplastic polymer and the filler prior to the extrusion coating has resulted in a remarkable improvement of the absorption speed. The anti fogging agent is an additive compounded with the polymer composition for the purpose of rendering the surface of the microporous film and the pore surface hydrophilic. The anti fogging agent is a surfactant selected from the group of sorbitan fatty acid ester such as sorbitan monooleate, sorbitan monolaurate, sorbitan monostearate and sorbitan tristearate; polyoxyalkylene sorbitan fatty acid ester such as polyoxyethylene sorbitan trioleate; glycerin fatty acid ester such as glycerin monooleate and glycerin monostearate; polyglycerin fatty acid ester such as diglycerin monooletae, digelycerinsesquilaurate, tetraglycerin monooleate and decaglycerin monolaurate; polyoxyalkylene alkyl ether such as polyoxyethylene lauryl ether; polyoxyalkylene fatty acid ester such as polyethylene monolaurate, polyoxyethylene trioleate; polyoxyethylene alkyl mercaptan such as polyoxyethylene dodecyl thioether; polyoxyethylene alkyl phenol such as polyoxyethylene nonyl phenyl ether; pentaerythritol fatty acid ester such as pentaerythritol monostearate; saccharose fatty acid ester such as saccharose laurate; polyoxyethylene fatty acid amide such as polyoxyethylene oleamide; aliphatic amine such as lauryl diethanolamine; and fatty acid amide such as oleamide. Particularly preferred is glycerin monooleate, since this surfactant provides for improved water resistance of the film as will be illustrated in the examples below.

In this invention, the microporous film is adhered on a support through an adhesive layer. The adhesive material can be of any materials that have good properties for adhering the microporous film on the support, and which is permeable for gas and liquid. Examples of such materials are included starch, gelatine, gums arabic, pectin, albumin and agar-agar. The adhesive layer may comprise further of inorganic particles such as silica, alumina, CaCO₃, or the mixture thereof. In order to enhance the adhesion properties, the microporous film and/or the support may be treated with corona treatment, plasma treatment or flame treatment prior to applying the adhesive layer.

Surprisingly it is found that the absorption speed of the microporous film that has been adhered to the support as described above, can be further increased by coating an aqueous solution containing water and surfactant. Said microporous film may either be a microporous film containing thermoplastic polymer and filler or a film containing polymer, filler and anti fogging agent. Depending on the type of the surfactant, a fraction of volatile solvent may be present therein in order to enhance the solubility of said surfactant in water. The suitable surfactant species can be selected from any surfactant that is classified as cationic surfactants, anionic surfactant, non-ionic surfactants or amphoteric surfactants.

Examples of anionic surfactants are including, but not limited to, the fatty acid surfactants such as the regular soaps, phosphate ester surfactants, sulphosuccinic acid alkyl ester such as Aerosol OT, sulphate ester surfactant such as sodium dodecylsulphate, sulphated fatty acid surfactants such as sulfated monoglycerides and other polyols, and sulphated alkanolamides, sulphated ethers, sulphated alkylphenol ethoxylates, aliphatic sulfonates such as sodium dodecylsulphonate, alkylaryl sulphonates such as sodium dodecyl benzenesulphonate and α-sulphocarboxylic acids and their derivatives.

Examples of suitable cationic surfactants includes the groups containing alkyl nitrogen compounds such as simple ammonium salts containing at least one long chain alkyl group and one or more amine hydrogens, and quartenary ammonium compounds in which all amine hydrogens have been replaced by organic radical substitution, and the groups of cationic surfactants those contain heterocyclic materials characterised by the N-alkylpyridum halides, salts of alkyl-substituted pyridines, morpholinium salts, and imidazolinium derivatives.

The nonionic surfactants include the polyoxy-ethylenes which have the general formula

RX(CH₂CH₂O)ₙH

where R is normally a typical surfactant hydrophobic group, but may also be a polyether such as polyoxypropylene and X is an O, N or another functionality capable of linking the polyoxyethylene chain to the hydrophobe. The “n” represent the average number of the oxyethylene units and should have a value of higher than 5 to impart sufficient water solubility. Another examples of non-ionic surfactants are the derivatives of sugar, derivatives of polyglycerols and other polyols.

The examples of amphoteric surfactants are those categorised as the ampholites such as aminocarboxyclic acids and lecithin, betaines and sulfobetaines.

The anionic surfactants including the group of alkylaryl sulphonate such as sodium dodecyl benzene sulphonate, the aliphatic sulfonates such as sodium dodecyl sulphonates and the sulphate ester surfactant such as Aerosol OT have received our preference. The preferred cationic surfactants comprises the groups that contain quartenary ammonium compounds, such as dodecyl trimethyl ammonium chloride.

The support which is used in this invention, is preferably coated on the back side with a polymer matrix comprises of at least a polyolefin resin and an anti-static agent. Furthermore, the support is selected from a paper, a photographic base paper, a synthetic paper or a plastic film.

Examples of the material of the plastic film are polyolefins such as polyethylene and polypropylene, vinyl copolymers such as polyvinyl acetate, polyvinyl chloride and polystyrene, polyamide such as 6,6-nylon and 6-nylon, polyesters such as polyethylene terephtalate, polyethylene-2 and 6-naphtalate and polycarbonate, and cellulose acetates such as cellulose triacetate and cellulose diacetate.

An ink receiving layer may be coated on the surface of the microporous film which has been adhered onto the support. The ink receiving layer is characterised by the hygroscopic properties of said layer and its high ability to fix the image with a precise dot size and to provide good image stability. The said ink receiving layer comprises binders, fine porous pigments particles selected from the groups of aluminum oxides such as boehmite and pseudo-boehmite and those of silica such as silica gel, fumed silica and precipitated silica, and optionally various known additives, including surfactants, mordant, etc.

Alternatively, an ink receiving layer comprising water soluble binder is also suitable to be coated on the surface of the microprous film. In this case the ink receiving layer does not substantially contain pigments. This ink receiving formulation provides better protection against the dye fading of the printed image than the earlier formulations.

Optionally the ink receiving layer may comprise other materials to improve the whiteness and the glossiness appearances of the ink jet medium. The suitable materials for the binder can be selected from gelatine or one of its modified products, poly (vinyl alcohol), NBR latex, cellulose derivatives, quartenary ammonium salt polymers, poly vinyl pyrrolidone, poly-ethylene-oxide, poly acrylic acid, polyurethane, or the combination thereof.

In order to further improve the gloss appearance and other additional properties, we may coat an over-coating layer on top of the ink receiving layer. This layer may comprise cellulose derivatives such as hydroxymethyl cellulose and hydroxyethyl cellulose, poly-vinyl alcohol or gelatine in combination with a suitable cross-linking agent. The over coating layer is non-porous but is ink permeable.

### EXAMPLES

The present invention will be explained in detail by the following non-limiting examples.

### Example 1

A microporous film involving the following process steps was produced by ACE S.A. in Belgium:

mixing polyolefin polymers, mainly comprising low density polyethylene (LDPE), a masterbatch containing 70 wt. % CaCO₃ particles having an average particle size of 1.2 μm and a masterbatch which is containing 15 wt. % of sorbitan ester;

extruding the mixture at 220° C. to form a film,

cooling the film and

stretching the film at 70° C. in the machine direction with a stretch ratio of 5.

Prior to stretching, the polyolefin film contained 50 wt. % of CaCO₃ and 1.5 wt. % of sorbitan ester.

The thickness of the film was regulated by determining the output of the extruder and the thickness of the stretched microporous film was measured with the Lorentzen & Wettre micrometer, model SE051D2. This film has a thickness of 31 μm. The microporous films was then attached to a support which was a 166 gr/m2 base paper by using an adhesive solution comprising gelatine and silica particles. Prior to attachment, the microporous film was corona treated.

### Example 2

A microporous film is produced according to the method as mentioned in example 1, except that the thickness of the microporous film is adjusted to 51 μm. The microporous film was attached to a base paper support which weight was 166 gr/m2 and subjected to all measurements.

### Example 3

A microporous film is produced with the same condition as mentioned in example 1, except that the average particle size of the CaCO₃ filler was 2.0 μm. The microporous film was attached to a base paper support which weight was 166 gr/m2 and subjected to all measurements.

### Example 4

A microporous film is produced with the same condition as mentioned in example 1, except that the average particle size of the CaCO₃ filler was composed of a mixture of particles having an average particle size of 1.2 μm and 2.0 μm in the ratio of 1:1. The thickness of the microporous film is 20 μm. The microporous film was attached to a base paper support which weight was 166 gr/m2 and subjected to all measurements.

### COMPARATIVE EXAMPLE 1

A microporous film is produced with the same condition as mentioned in example 1, except that the thickness of the microporous film was increased to 70 μm. The microporous film was adhered to a base paper having the same specification as in example 1 and was subjected to all measurements.

### Example 5

A microporous film is produced with the same materials and process conditions as mentioned in examples 2, except that the microporous film did not contain sorbitan ester, has a thickness of 33 μm and has an average CaCO₃ filler particle size of 2.0 μm.

This film was attached to a base paper at the same manner as in example 1.

### Example 6

The microporous film according to example 5 was adhered onto a 166 gram/m2 base paper and was treated with an aqueous solution containing 1 wt. % Aerosol OT, which is a anionic surfactant, purchased from Nippon Yushi, Japan. For this purpose, said aqueous solution was coated on the microporous ink jet substrate by using a K Hand Coater, bar nr. 5 and dried at room temperature.

### Example 7

An ink-receiving coating composition was prepared by mixing a 40 wt. % dispersion of HP-14 having pH 2, with a 20 wt. % polyvinyl pyrolidone solution (PVP) with MW of 20 KD, purchased from Sigma. The HP-14 contains alumina hydrate of boehmite structure and is purchased from Sasol, Germany. The mixing ratio between the PVP and HP-14 in the coating liquid was 1:11. The ink-receiving coating liquid was then applied onto the adhered microporous film produced according to the example 2 by means of a K Hand Coater, bar nr. 5, and dried at room temperature conditions. The resulting recording medium was subjected to a printing test as described below, of which the results are shown in table 3.

### Example 8

A microporous film was produced under the same conditions as mentioned in example 1, except that the average particle size of the CaCO₃ filler was 2.0 μm and the thickness of the microporous film was adjusted to 53 pn. This film was used for the ink penetration speed experiment described below.

### Example 9

A microporous film was produced under the same conditions as mentioned in example 8, except that the microporous film contained gylcerine monooleate instead of sorbitan ester. This film was used for the ink penetration speed experiment described below.

Physical Properties of the Microporous Films

The physical properties of the microporous films were analysed with a Mercury Porosimeter AutoPore IV 9500 from Micromeritics. The software of this analytical equipment calculates the average pore diameter—in nm—, the total void volume—in ml per gram—, the porosity—in percentage—, and the incremental void volume as function of its pore size diameter—in ml per gram—. The results of these physical properties are shown in table 2.

The glossiness of the obtained microporous ink jet substrate was measured with Dr. Lange Reflectometer model REFO-3D at an angle of 850 and are shown in table 3.

Printing Test:

The microporous ink jet substrate was further subjected to an ink-jet printing test. A standard pattern comprising the colours magenta, cyan, yellow, green, red, blue and black in 5 different densities was printed on the above mentioned microporous substrates. The printers which were used herein were Canon BJC 6200 and/or Epson PM 770C.

Directly after printing the standard pattern, a white paper was overlaid on the printed microporous substrate and a stainless steel roller with a weight of 10 kg was rolled over the white paper slowly. The drying speed of the microporous substrate was determined by analysing visually the colour density of the print which was transferred to the white paper. A lower density at the white paper means a better drying speed of the ink jet solvent. The results of the printing test can be found in table 3.

The thickness and the applied CaCO₃ particle size of the various microporous films described in the examples are summarised in table 1.

Ink Penetration Speed Experiment with Black EPSON Ink:

In order to analyse the interaction strength between the surfactant and the microporous polymer, a so called ink penetration speed experiment was carried out. For this purpose, a drop of EPSON Black ink type 1C1BK02 (suitable for EPSON printer type 770) with a volume of 02.μm, was put on the upper surface of the microporous film described in example 8 and 9. The ink penetration speed is defined by the time needed for this drop to reach the backside of the film. A short ink penetration speed indicates a high absorption capacity of the microporous film.

The results of the above mentioned ink penetration speed was compared to those where the microporous films of examples 8 and 9 have been completely dipped in water for 4 minutes and dried prior to put the ink drop thereon.

The results of the ink penetration speed is summarized in table 4.

TABLE 1

| | Thickness of | | |
|---|---|---|---|
| | microporous | Average particle size | |
| | film [μ] | of CaCO3 filler [μm] | Surfactant type |
| Example 1 | 31 | 1.2 | Sorbitan Ester |
| Example 2 | 51 | 1.2 | Sorbitan Ester |
| Example 3 | 31 | 2.0 | Sorbitan Ester |
| Example 4 | 20 | mixture of 1.2 pm and | Sorbitan Ester |
| | | 2.0 pm (mixing ratio | |
| | | 1:1) | |
| Comparative | 70 | 1.2 | Sorbitan Ester |
| - 1 | | | |
| Example 5 | 33 | 2.0 | None |
| Example 6 | 33 | 2.0 | Aerosol OT |
| Example 7 | 51 (same film | 1.2 | Sorbitan Ester |
| | | as ex.-2) | |
| Example 8 | 53 | 2.0 | Sorbitant Ester |
| Example 9 | 53 | 2.0 | Glycerine mono- |
| | | | oleate |

The physical properties of the microporous films as determined by the mercury porosimeter are shown in table 2.

TABLE 2

| | | | Total void | Void volume distribution | | |
|---|---|---|---|---|---|---|
| | Average pore | | volume | [%] | | |
| | diameter | Porosity | [mL/ | pore < | pores between | pores > |
| | [nm] | [%] | gram] | 50 nm | 50 nm & 1000 nm | 1000 nm |
| Example 1 | 161 | 47 | 0.5087 | 8 | 43 | 49 |
| Example 2 | 135 | 40 | 0.420 | 8 | 49 | 42 |
| Example 3 | 249 | 57 | 0.7413 | 6 | 35 | 59 |
| Example 4 | 228 | 55 | 0.6925 | 6 | 39 | 55 |
| Comparative 1 | 79 | 26 | 0.2163 | 9 | 65 | 26 |
| Example 5 | 186 | 50 | 0.5849 | 4 | 49 | 47 |
| Example 6 | 186 | 50 | 0.5849 | 4 | 49 | 47 |

The pore size distribution is split up in 3 fractions with pores smaller than 50 nm, pores between 50 nm and 1000 nm and pores bigger than 1000 nm.

The printing results of the microporous film and the gloss measurements are listed in table 3.

TABLE 3

| | |
|---|---|
| Drying speed both for | |
| Canon and for Epson | Gloss at 85° |

| | Canon | Epson | (before printing) |
|---|---|---|---|
| Example 1 | ◯ | — | 15% |
| Example 2 | Δ | — | 22% |
| Example 3 | ◯ | ◯ | 13% |
| Example 4 | ◯ | ◯ | 18% |
| Comparative 1 | X | X | 27% |
| Example 5 | — | ◯ | 17% |
| Example 6 | — | ◯ | 17% |
| Example 7 | Δ | — | 50% |

Definition
◯ = Good
A = Not totally dry but still acceptable
X = Bad (not acceptable)
— = Not tested

TABLE 4

| | | | | | With |
|---|---|---|---|---|---|
| | | | | | dipping 4 |
| | Thickness of | | | Without | minutes in |
| | microporous | | | dipping | water |
| | film | Particle | Surfactant | Ink penetration | |
| Example | [μm] | size | type | speed [seconds] | |
| 8 | 53 | 2.0 | Sorbitan | 14 | 57 |
| | | | ester | | |
| 9 | 52 | 2.0 | Glycerine | 14 | 14 |
| | | | monooleate | | |

The conclusions which can be derived from table 1-4 is that the gloss value of the microporous film depends on the average pore diameter of the microporous film. The smaller the average pore size, the higher the gloss value at 85°. But on the other hand, the drying speed of the microporous ink jet media is increasing as the average pore diameter is becoming larger. There is thus an optimum where an acceptable drying speed can be obtained at an acceptable gloss value.

Secondly, the importance of the pore size distribution of the microporous film can be clearly seen in the comparative 1. The absorption speed of the microporous film is unacceptable low when the pore size distribution and the porosity of the microporous film do not comply with the characterisation according to this invention.

Thirdly, example 7 shows clearly that the glossiness of the microporous film used in example 2 can be improved significantly by coating an ink receiving layer on top of said film. Besides that, the image printed on the ink jet media of example 7 has a high colour density.

Finally, example 8 and 9 clearly show the influence of surfactant type contained in the master batch when the film of the ink jet media is contacted with water or aqueous substances. By choosing glycerine monooleate as a surfactant, the interaction between the surfactant and the polymer material of the microporous film improved, so that the ink penetration speed may be maintained, even after treating the film with water. This is important, for instance, for applications wherein “water rich” ink receiving coating coniposition is coated on the microporous film.

1. Ink jet recording medium comprising a support and a microporous film adhered to said support, which film has an average pore diameter of between 50 nm and 1000 nm, wherein said film is obtained by film casting a resin to which a surfactant as anti-fogging agent is admixed.

2. Medium according to claim 1, wherein said microporous film is obtainable by a method comprising the successive steps of mixing of thermoplastic resins with at least one filler and optionally said anti-fogging agent, extruding said mixture at elevated temperatures to form a film thereof, pre-stretching the film, cooling said film until the film is solidified and stretching said cooled film to form said microporous film.

3. Medium according claim 1, wherein said microporous film is obtainable by a method comprising the successive steps of:
preparing a mixture consisting of a polyolefin matrix, containing at least one polymer and at least one mineral and/or organic filler; extruding at least one ply by hot-casting the mixture;
pre-stretching the ply with a drag roll;
cooling and solidifying the pre-stretched ply using the drag roll;
drawing the solidified ply at sufficient temperature to form the micro-porous film, whereby:
the cooling of the pre-stretched melting ply by the drag roll is partial and limited in a controlled manner at a temperature within the range required for its drawing; and
the drawing of the ply, brought to the required temperature for drawing through partial cooling is carried out by traction at the time of its tangential separation from the drag roll, the said roll acting as take-up roller for drawing.

4. Medium according to claim 1, wherein said microporous film has a thickness of less than 150 μm.

5. Medium according to claim 4 having a thickness of from 15-100 μm.

6. Medium according to claim 1, wherein said microporous film is characterised by:
an oriented thermoplastic film comprising at least a filler,
said film having interconnecting channels between the pores, with a void volume between 30 to 80 volume percent of the total microporous film, and
having a volume of pores with a pore diameter between 50 μm and 1000 nm of less than 60 volume % of the total void volume of said microporous film, as determined by the mercury intrusion porosimetry method.

7. Medium according to claim 1, wherein the total void volume of said microporous film is at least 0.3 ml per gram of said microporous film.

8. Medium according to claim 1, wherein the volume of pores having pore diameter larger than 1000 nm is at least 40 volume % of the total void volume of said microporous film.

9. Medium according to claim 1, wherein said microporous film comprises 35 to 80 weight percent of filler.

10. Medium according to claim 1, wherein said filler has an average particle size of less than 40 μm.

11. Medium according to claim 1, wherein said fillers in the microporous film have a bimodal particle size distribution.

12. Medium according to claim 10, wherein the particle size of the largest peak in the distribution is at least 1.5 times the peak of the smallest particle size.

13. Medium according to claim 2, wherein said filler comprises calcium carbonate, barium sulphate, silica, titanium dioxide or a mixture thereof.

14. Medium according to claim 1 wherein the anti-fogging agent is a surfactant selected from the group consisting of sorbitan fatty acid ester, polyoxyalkylene sorbitan fatty acid ester, glycerin fatty acid ester, polyglycerin fatty acid ester, and polyoxyalkylene ether, or mixtures thereof.

15. Medium according to claim 14, wherein said surfactant is glycerine monooleate.

16. Medium according to claim 14, wherein the amount of said anti-fogging agent is less than 10 wt % of the total weight of said microporous film.

17. Medium according to claim 1, wherein said microporous film is treated with an aqueous solution comprising surfactant after adhering the film on the support.

18. Medium according to claim 17, wherein the surfactant is selected from the group consisting of non ionic surfactants, anionic surfactants, cationic surfactants and amphoteric surfactants.

19. Medium according to claim 17, wherein the surfactant is selected from the group consisting of alkylaryl sulphonates, alkyl sulphate ester, sulphosuccinic acid alkyl ester, aliphatic sulphonates, and quarternary ammonium compounds.

20. Medium according to claim 17, wherein the dry amount of said surfactant applied on said microporous film is between 1.5 and 50 gram/m2.

21. Medium according to claim 1, wherein the thermoplastic resin is selected from the group consisting of polyolefin, polyethylene, polypropylene, co-polymers of ethylene and alpha-olefins, co-polymers vinyl ethylene-acetate, methyl ethylene-acrylate, ethyl ethylene-acrylate, and acrylic ethylene-acid and the ionomers, or the mixture thereof.

22. Medium according to claim 1, wherein said support is a paper, a photographic base paper, a synthetic paper or a film substrate.

23. Medium according to claim 1, wherein said support is laminated on the opposite side of where the microporous film is adhered and with the microporous film including a polymer matrix having at least a polyolefin resin.

24. Medium according to claim 1, wherein an ink receiving layer including binder, is coated on the surface of said microporous film.

25. Medium according to claim 24, wherein said ink receiving layer further comprises inorganic particles.

26. Medium according to claim 25, wherein said inorganic particles in the ink receiving layer comprises silica, boehmite, pseudo-boehmite or combinations 10 thereof.

27. Medium according to claim 25, wherein said binder in the ink receiving layer comprises gelatins, polyvinyl alcohol, polyvinyl pyrolidone, polyethylene-oxide, poly acrylic acid, polyurethane, cellulose derivatives or the mixtures thereof.

28. Medium according to claim 24, further comprising an ink-permeable protective layer on top of said ink receiving layer.

29. Medium according to claim 28, wherein said protective layer comprises hydroxypropyl methyl cellulose, polyvinyl alcohol or gelatin.

30. A hydrophilic, and hygroscopic microporous film, which is obtained by treating a film comprising an oriented thermoplastic polymer and at least one filler, is permeable to air and water vapour, has a void volume between 30 and 80 volume percent of the total film, and has a average pore diameter between 50 nm and 1000 nm as determined by the mercury intrusion porosimetry method, with an aqueous solution comprising at least a surfactant.

31. An ink jet recording medium comprising at least a support and the microporous film according to claim 30 adhered onto said support.

32. A method of forming a permanent, precise ink jet image comprising the step of:
providing an ink jet recording medium, and
introducing ink jet ink into contact with the medium in the pattern of a desired image.
